(19) United States
(12) Patent Application Publication
(10) Pub. No.: US 2013/0141438 A1
(43) Pub. Date: Jun. 6, 2013

(54) SYSTEM FOR INPUTTING AND DISPLAYING DATA

(71) Applicant: Frédéric Neftel, Lausanne (CH)

(72) Inventor: Frédéric Neftel, Lausanne (CH)

(73) Assignee: DEBIOTECH S.A., Lausanne (CH)

(21) Appl. No.: 13/806,953

(22) PCT Filed: Jun. 9, 2011
(86) PCT No.: PCT/IB2011/052510

§ 371 Date: Jan. 30, 2013

(30) Foreign Application Priority Data
Jun. 25, 2010 (IB) PCT/IB2010/052926

(51) Int. Cl. G06T 11/20

(52) U.S. Cl. CPC G06T 11/206
USPC 345/440

(57) ABSTRACT

System for inputting and displaying data comprising a programming screen, means for inputting data and means for displaying said data on said screen, characterized in that it comprises furthermore a series of indicators and means for activating said indicators which are adapted in such a way as to activate and to associate a specific indicator for each type of data to be input.

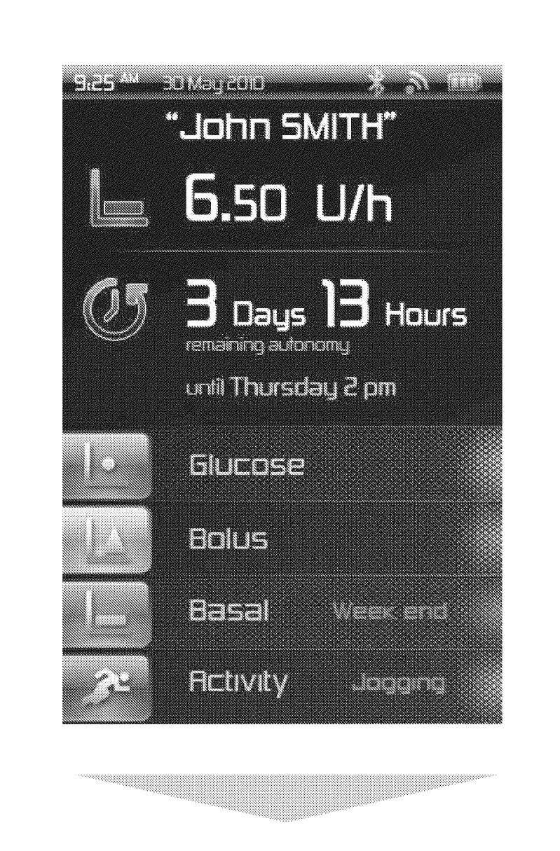

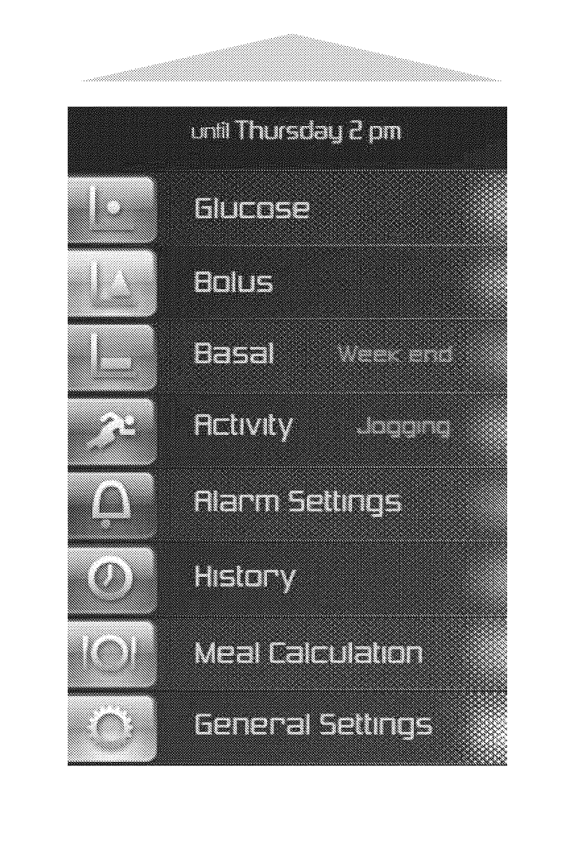

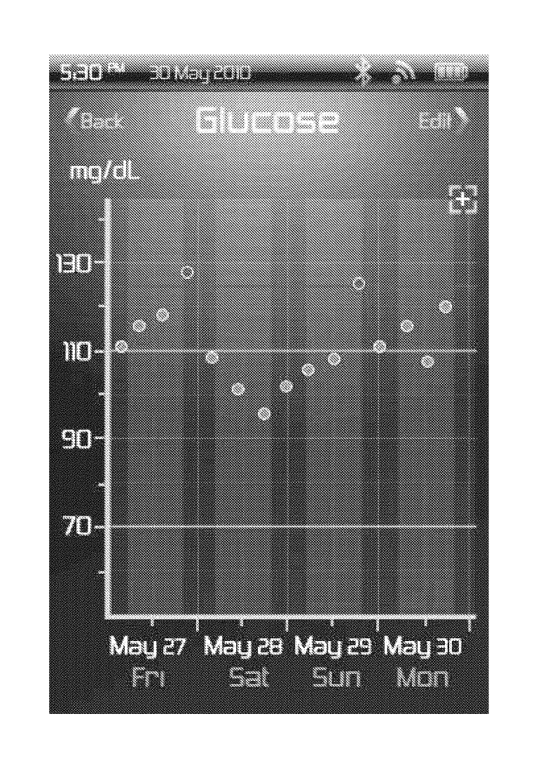

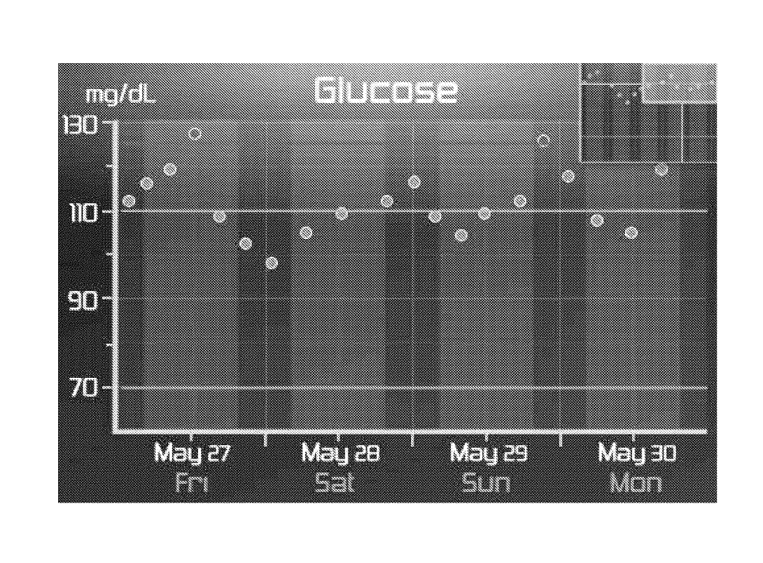

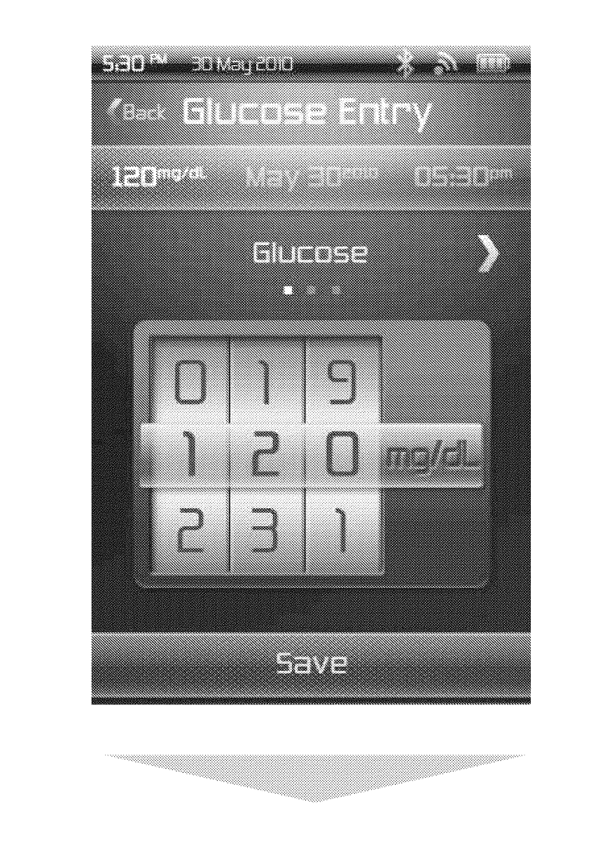

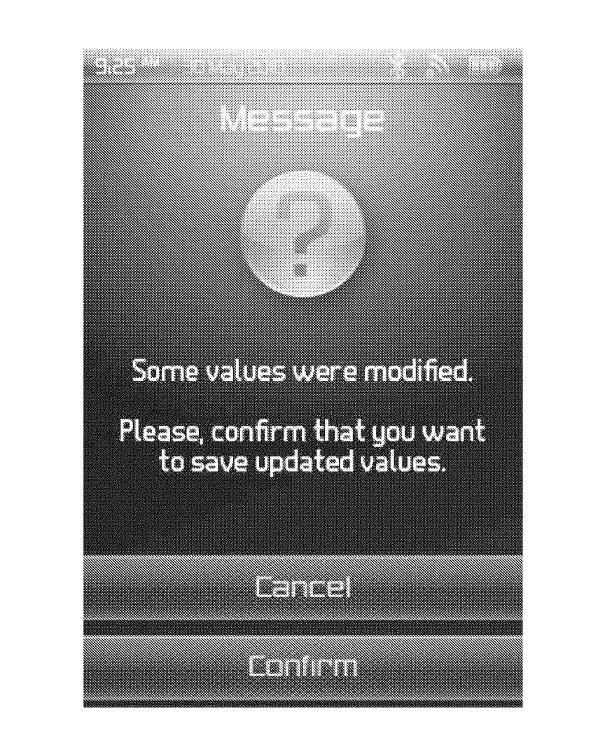

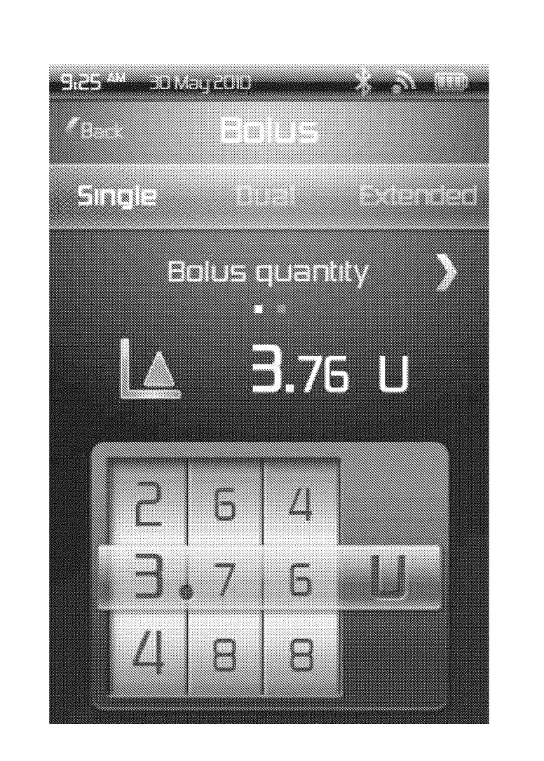

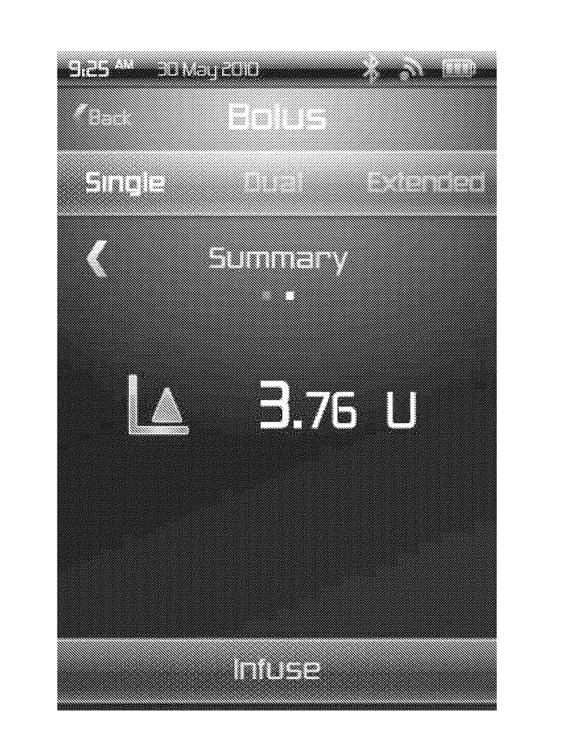

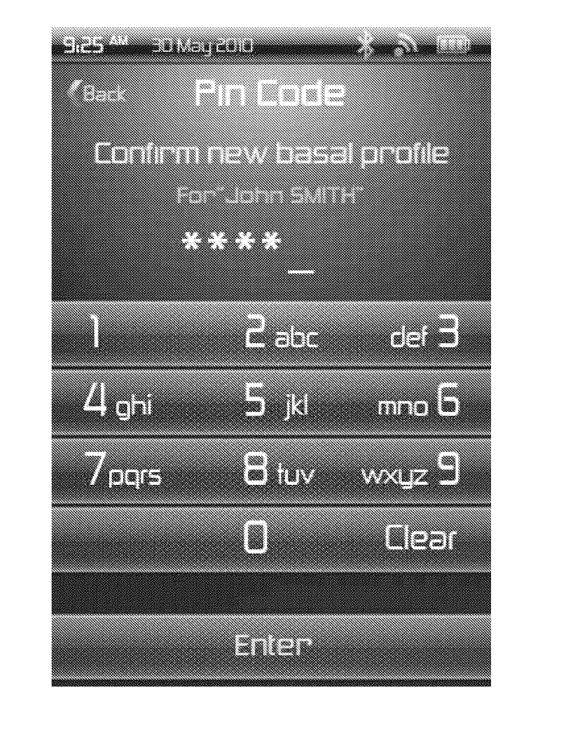

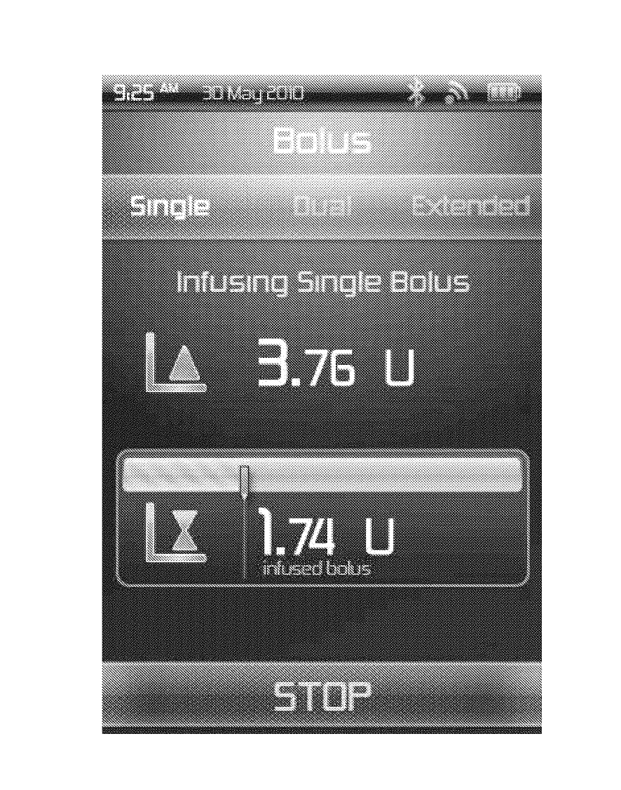

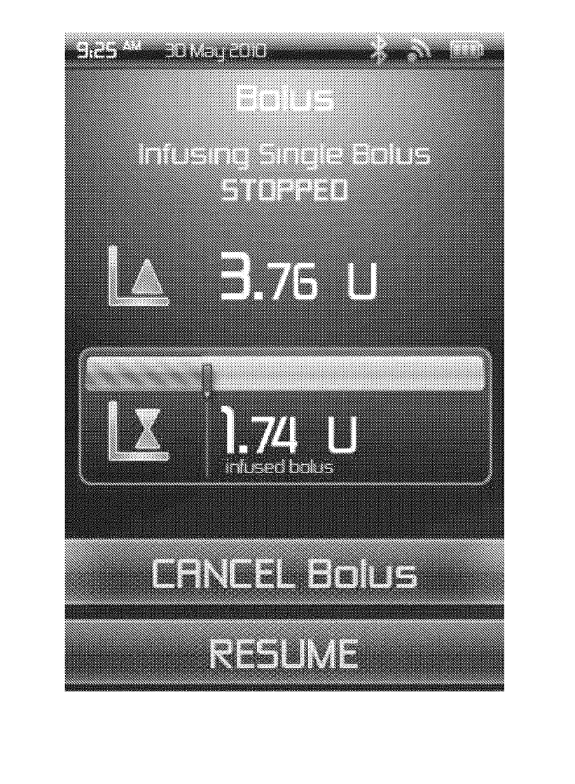

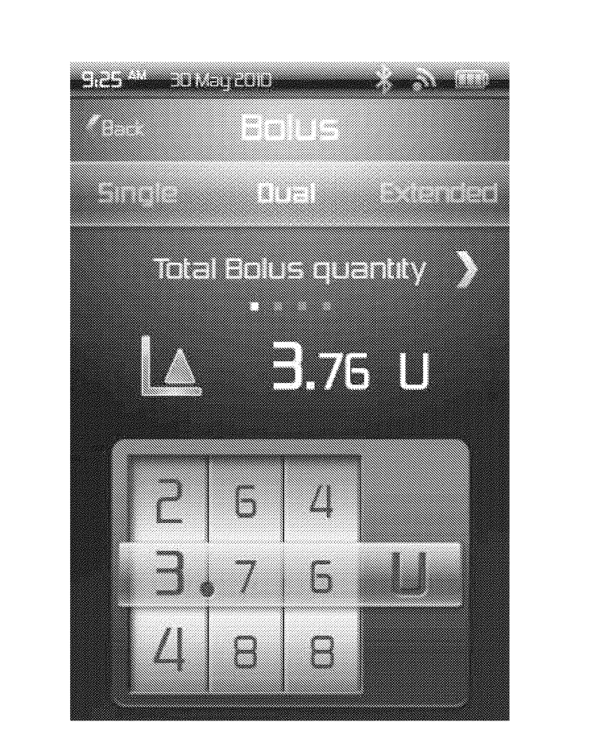

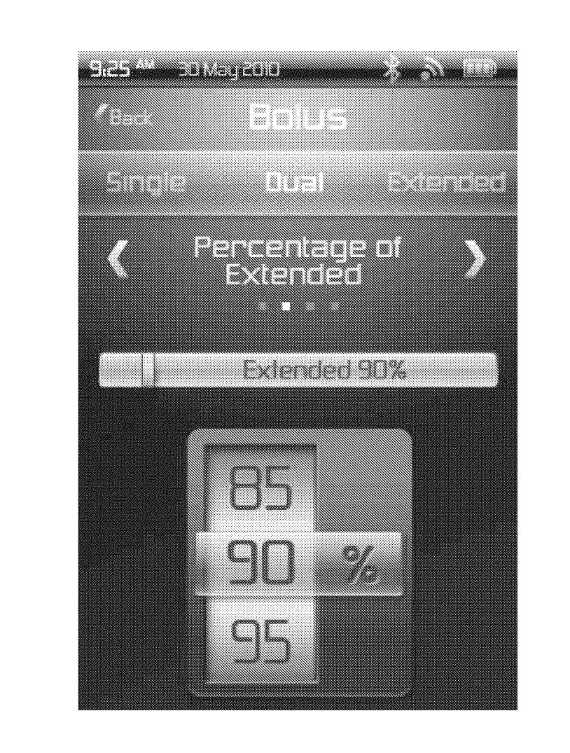

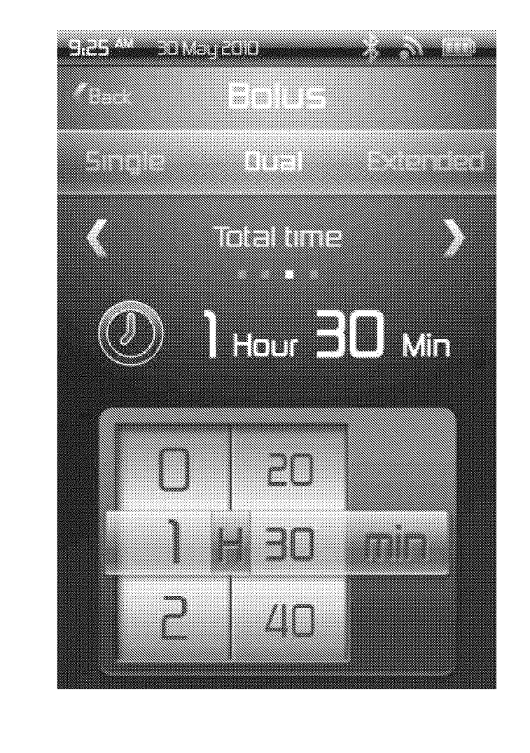

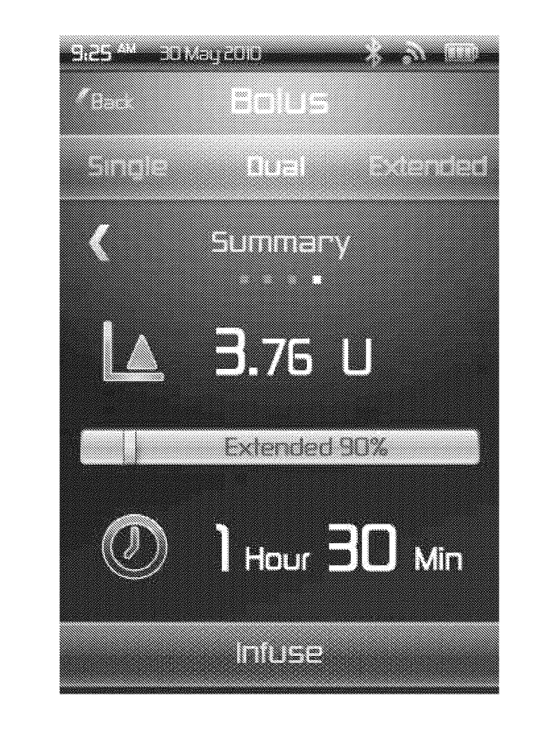

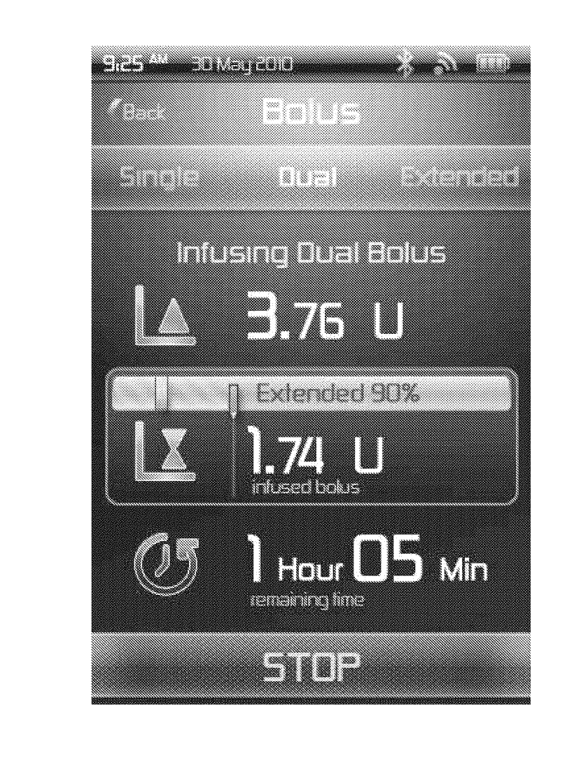

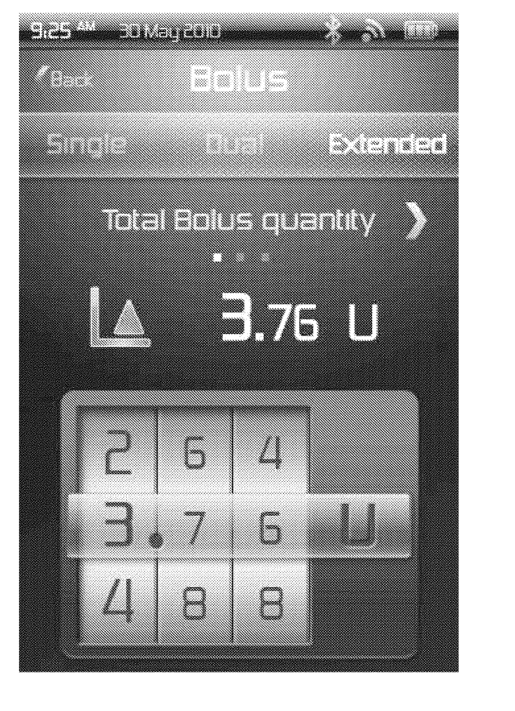

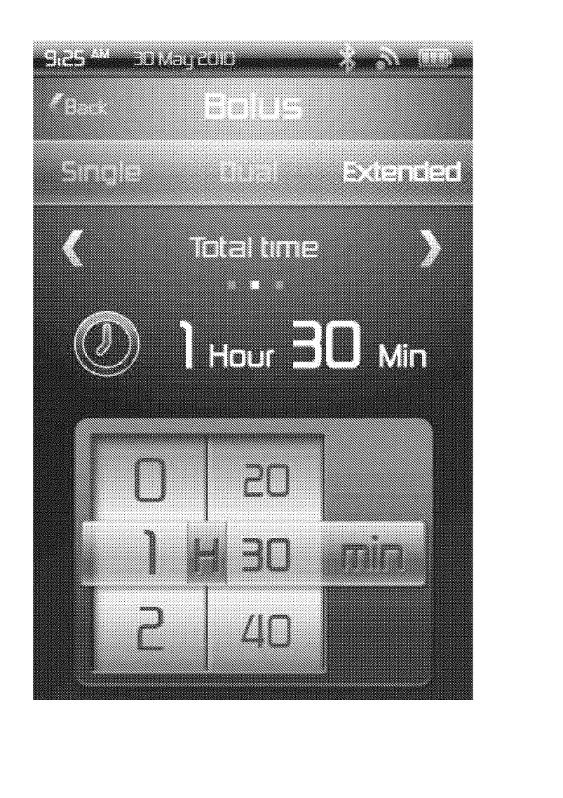

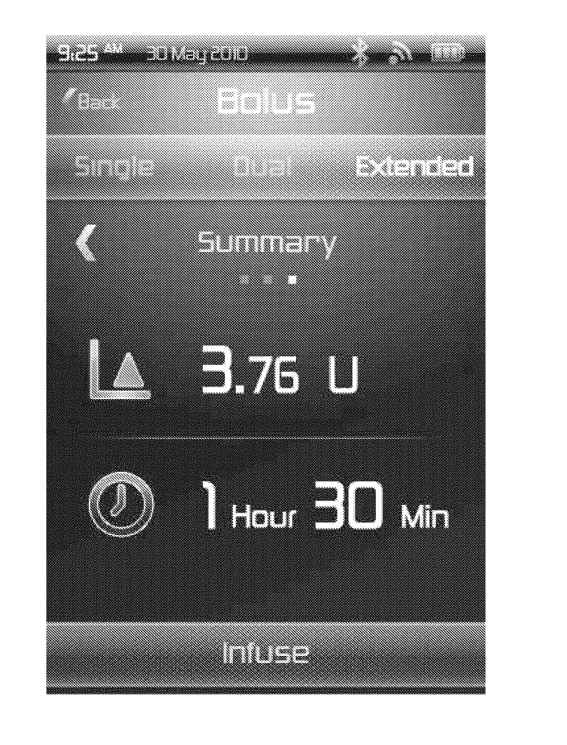

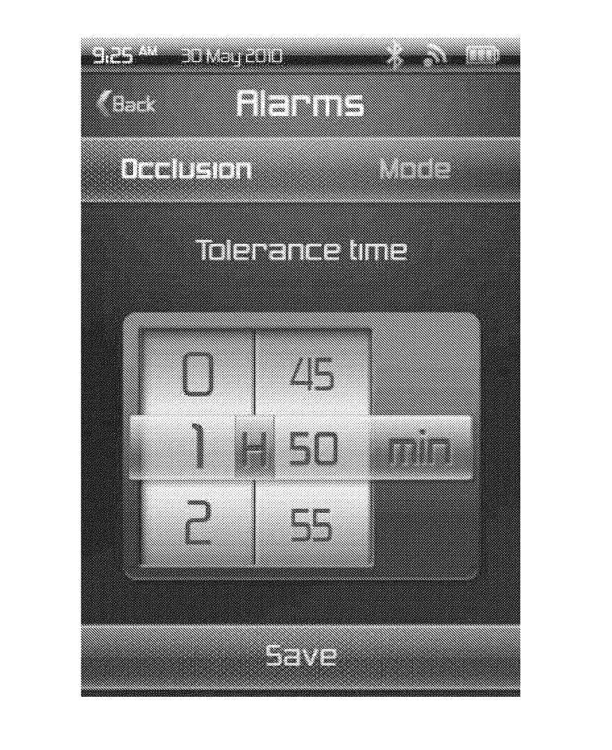

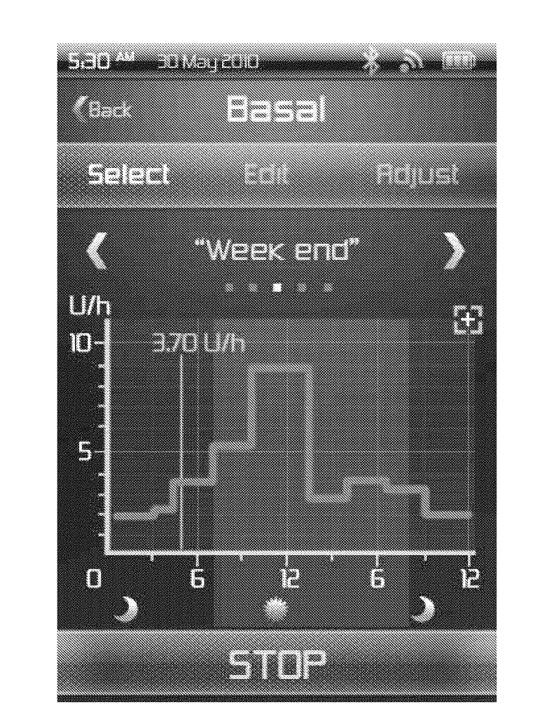

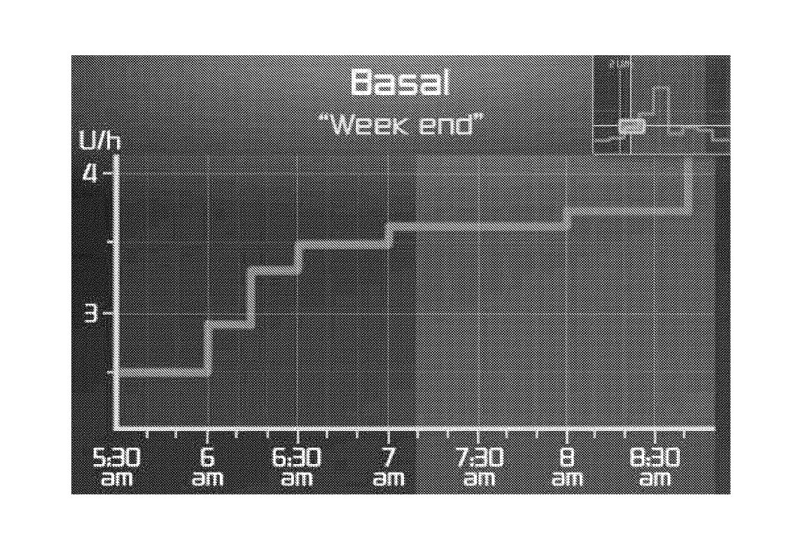

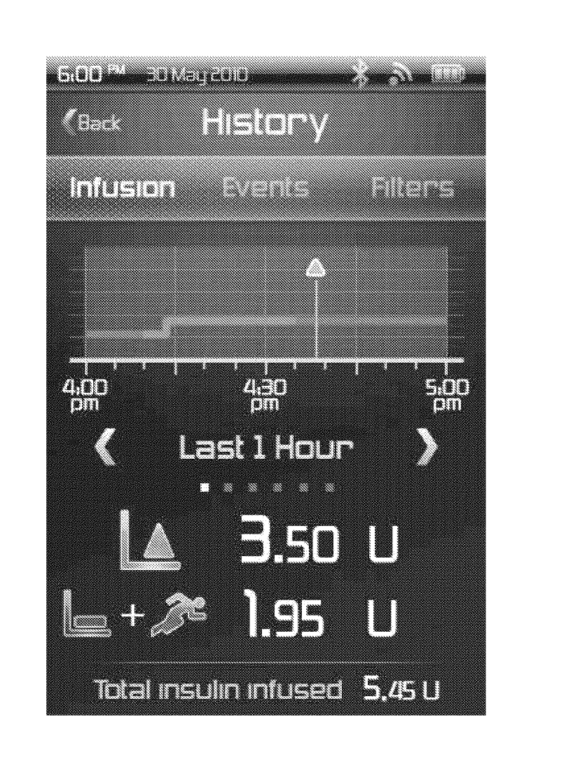

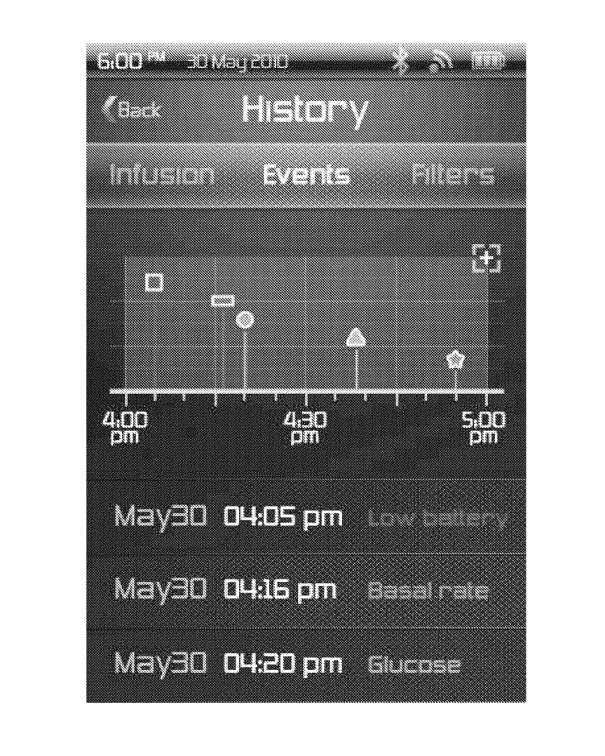

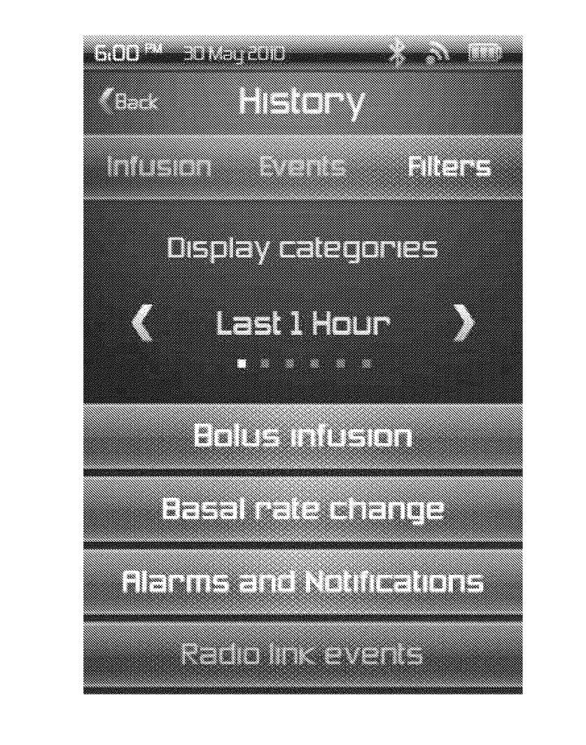

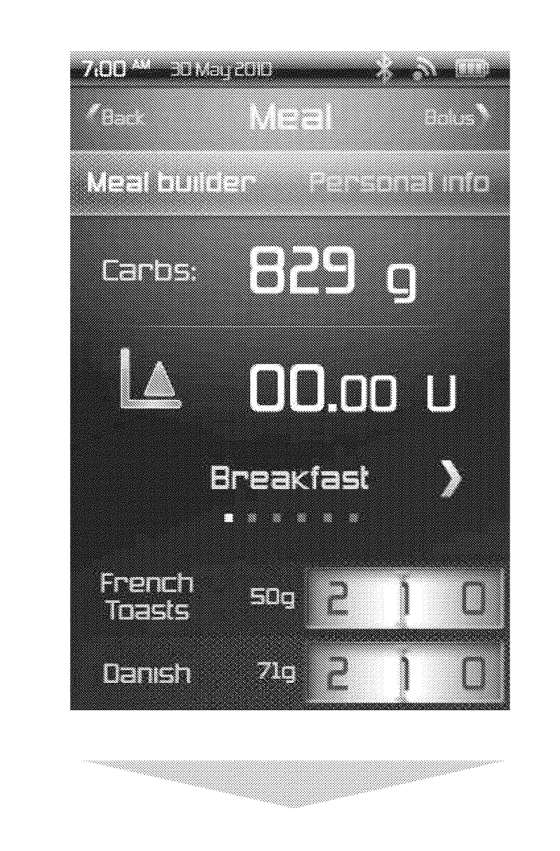

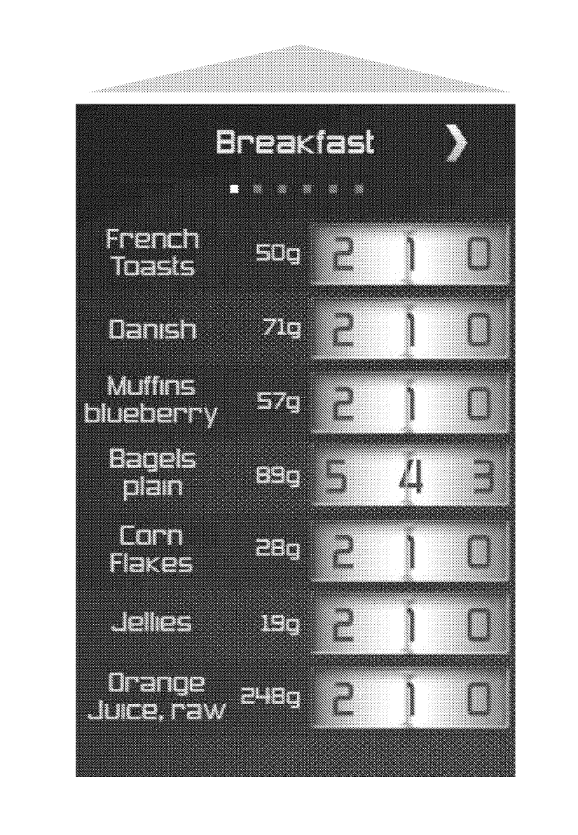

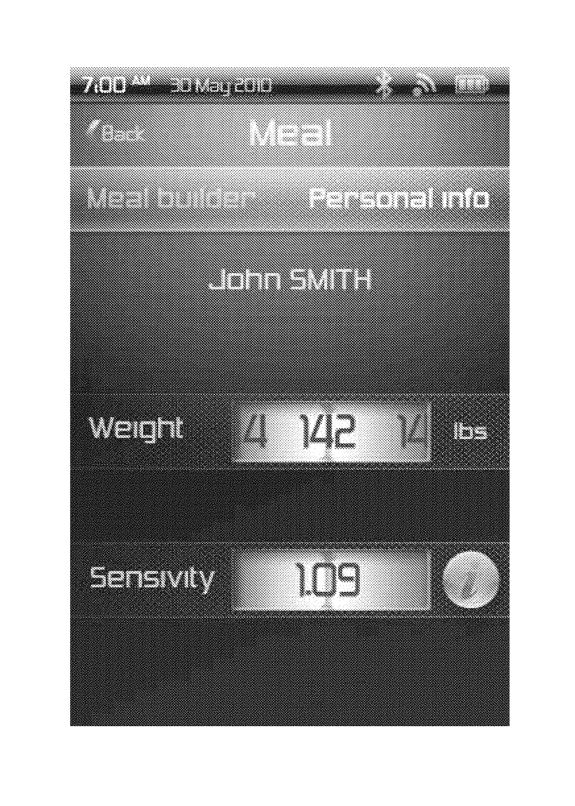

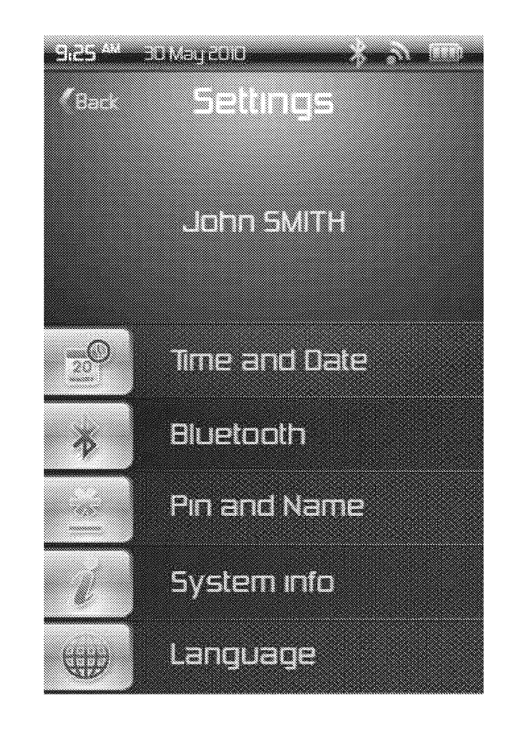

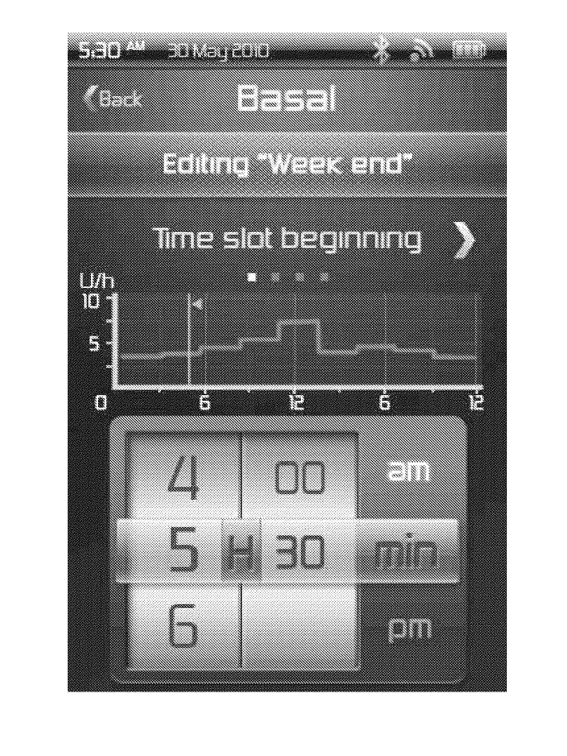

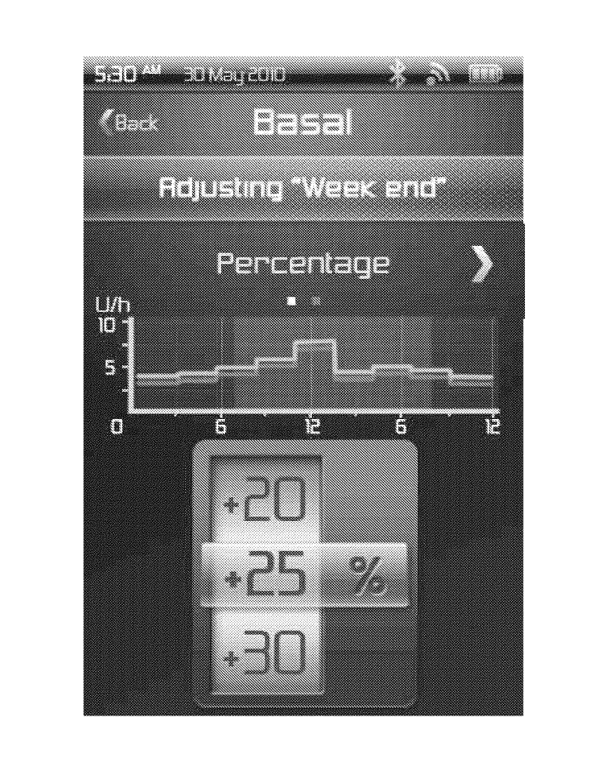

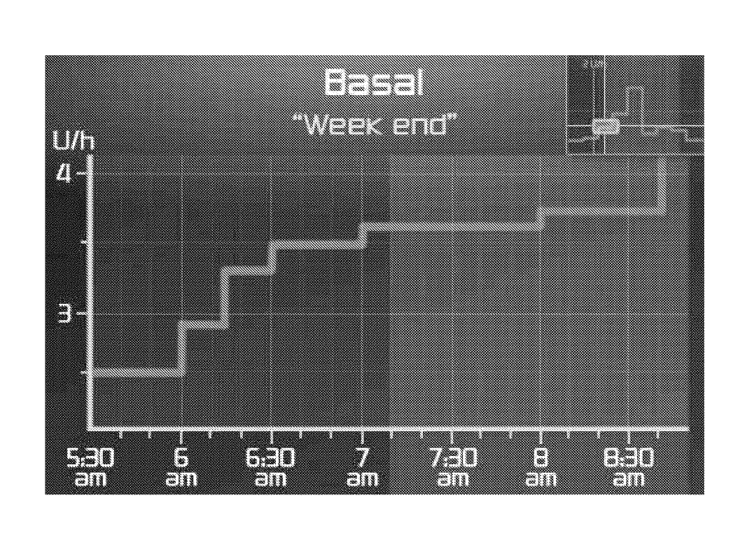

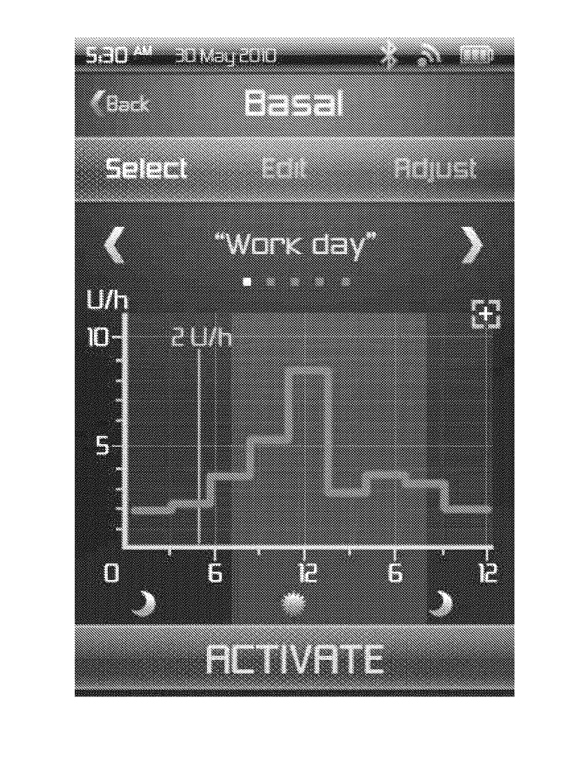

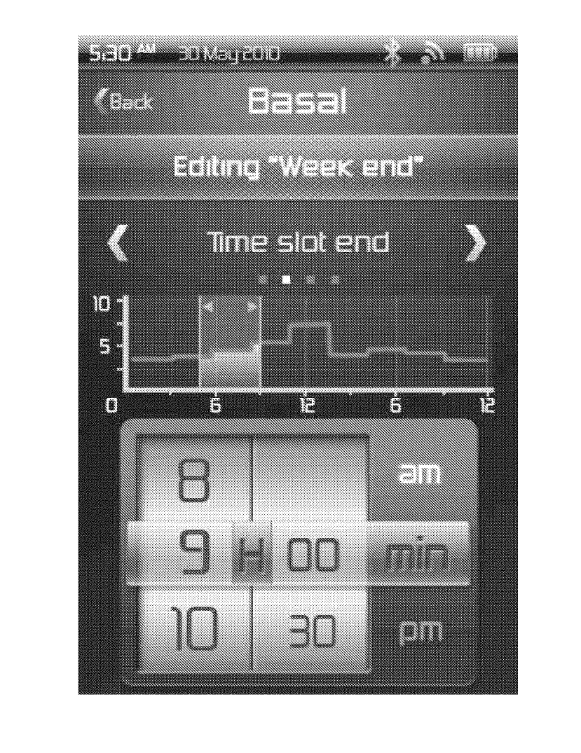

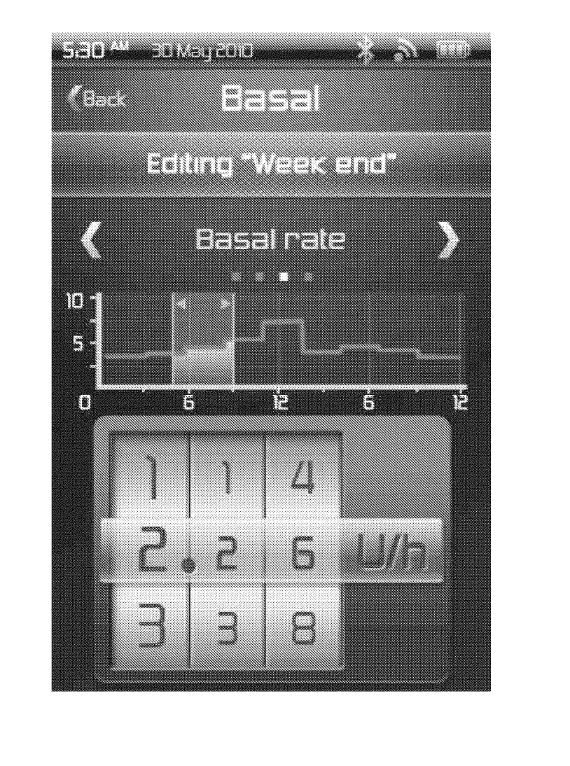

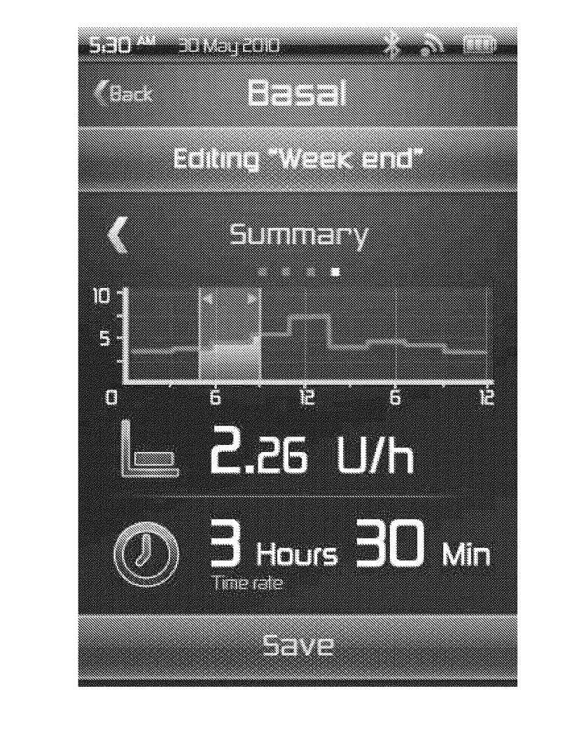

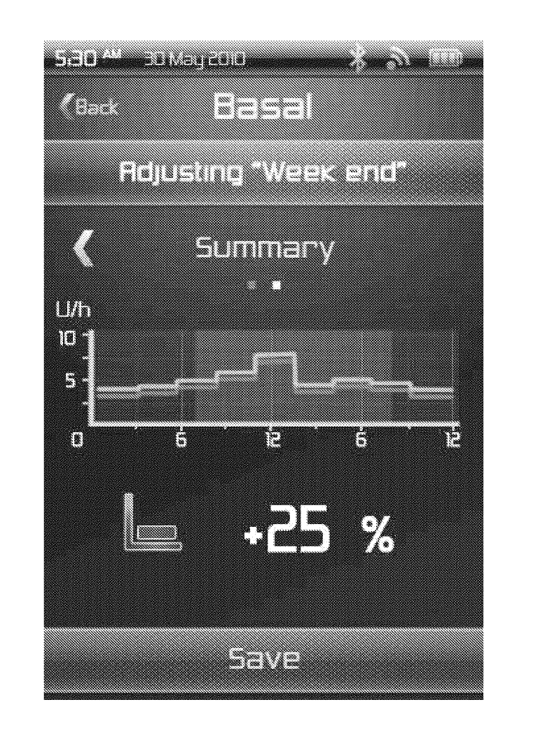

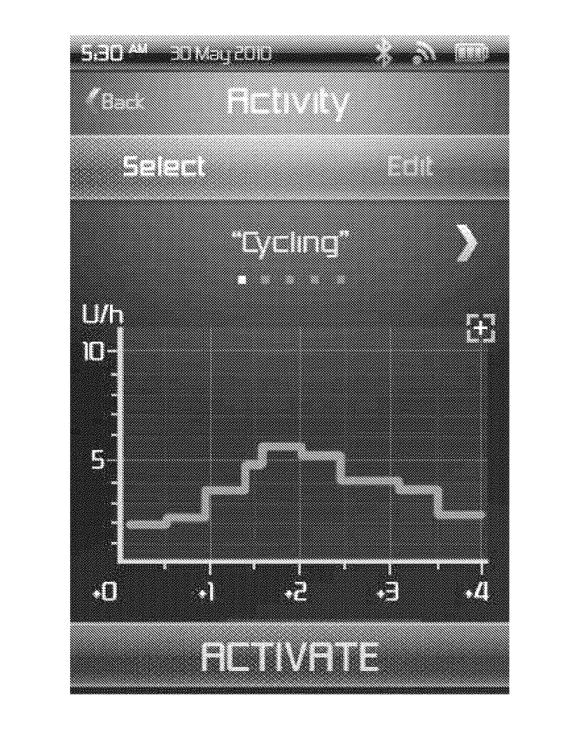

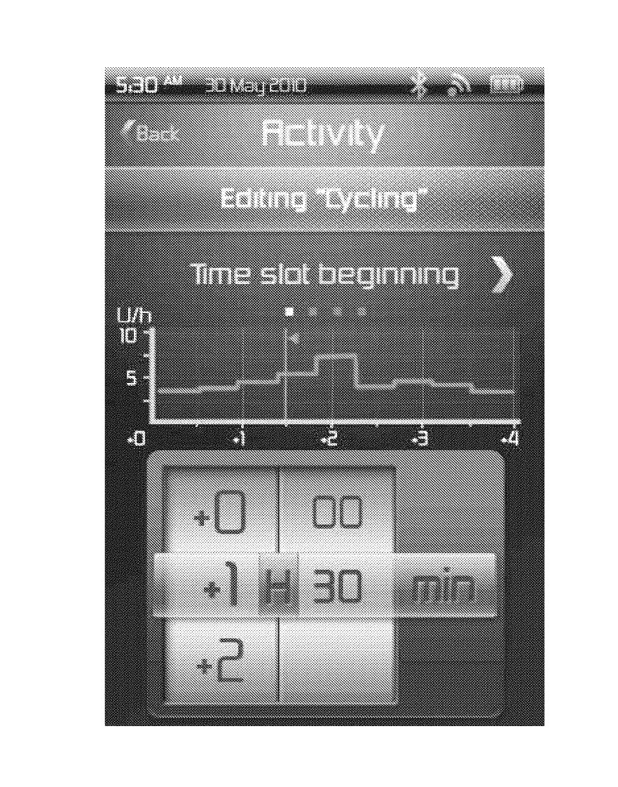

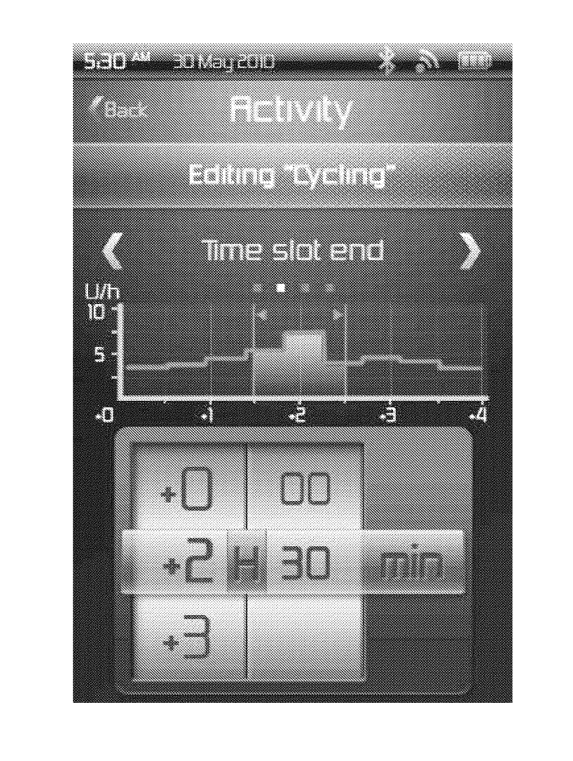

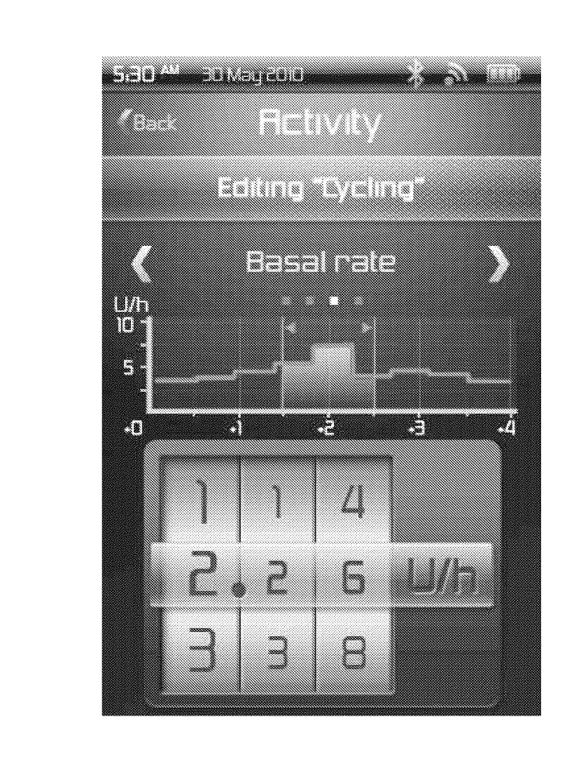

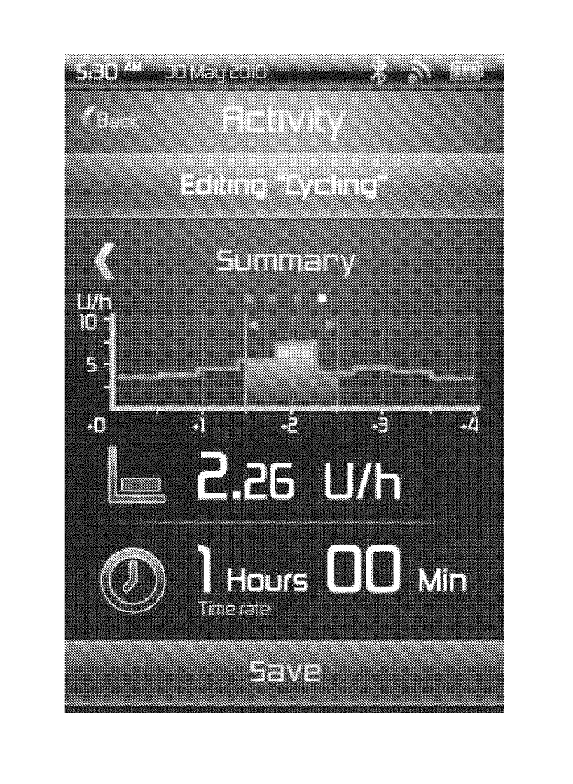

### FIELD OF THE INVENTION

The present invention lies within the field of programming a process by the introduction of data which are displayed on a screen. It is particularly intended for the medical field, notably for programming treatments.

### STATE OF THE ART

Very frequently, in fact too frequently, accidents occur that are caused by human errors linked to confusion in the information supplied by programming screens. The programmer in fact thinks that he is inputting and/or viewing data concerning a specific function whereas it is data relating to another function. This risk of confusion is particularly present in the case of the programming of insulin pumps for which the programmed dose is very important. An error between the programming of a bolus and a basal rate can have serious consequences for the patient. Although a different icon for each function does indeed reduce the risk of confusion, it is not sufficient to avoid such errors. The same applies for a pain-relief treatment (morphine-based), in the case of confusion between the programming of the bolus (or of the “lock” time) and the basal rate.

It should be noted that the occlusion of a pump is often originated by a pressure sensor which is triggered when a certain limit has been reached, said limit occurring fairly late (e.g. after 2U of insulin missed). In as much as the detection can be much more precise (e.g. 0.02U), it may be desirable to program a limit time before triggering the alarm, said time being programmed according to the condition of the patient (who can tolerate an absence of injection for 30 minutes, 1 h or 2 h for example), which gives a chance for the pump to detect a lifting of occlusion if the latter occurs during the programmed time and not, in this case, alarm the patient during a basal injection.

Thus, rather than a quantity of insulin, it is the duration which is used as the limiting factor which better matches clinical criteria than the dose.

It will also be noted that the use of a remote control offers the patient additional comfort, but also represents a risk should said remote control be taken over by a third party. This is particularly true given the fairly long range of the Bluetooth remote controls (e.g. 10 m and more).

EXPLANATION OF THE INVENTION

The problem that the present invention proposes to resolve lies at the level of the risk of error in the inputting of data on a programming screen.

In the invention, the solution to the abovementioned problem consists of a system for inputting and displaying data comprising a programming screen, data input means and means for displaying said data on said screen, characterized in that it also comprises a series of indicators and means for activating said indictors which are adapted so as to activate and associate a specific indicator for each type of data to be input.

Indicators can be of any type, e.g. sound (each function has an associated specific melody, etc.).

Preferably, the indicators are of the visual type.

Advantageously, each indicator comprises a unique color. It may, however, comprise other visual elements (graphics, logos, regular geometrical shapes, etc.).

According to a particularly interesting variant, each indicator comprises a screen background.

It is also possible to associate a specific color (letters and/or digits colored red for a function A and colored blue for a function B, etc.) with each type of data displayed.

Each indicator may also or alternatively comprise a unique icon. The color of the icon may be identical to the screen background which is associated with it.

The system according to the invention can be used in association with a pump intended to administer medicines, e.g. insulin, morphine, catecholamines, anticoagulants, hormones or peptides.

It may comprise a pop-up menu reprising the colors for each type of data, each type of data representing a function of the system.

Advantageously, it also comprises confirmation pages for receipt reprising the basic color of the chosen function.

It may be useful to provide colors which also enable color-blind people to make the distinction (possible green-red or blue-yellow confusion).

If a remote control is used, a wireless connection between the remote control and the pump will preferably be chosen.

It is also possible to program the triggering time of an alarm following a detection of occlusion instead of an injection threshold missed because of this occlusion.

It is also possible to provide the system with means which request a pin code in order to prevent the risks of accidental programming by a third party who might have the remote control.

The invention is described in more detail hereinbelow by means of examples illustrated by the following figures which represent different screen displays for programming a pump for the administration of insulin. It should be noted that, for each function (e.g. basal or bolus), the color of the screen background is unique.

1. A system for inputting and displaying data comprising a programming screen, data input means and means for displaying said data on said screen, characterized in that it also comprises a series of indictors and means for activating said indicators which are adapted so as to activate and associate a specific indicator for each type of data to be input.

2. The system as claimed in claim 1, in which the indicators are of the visual type.

3. The system as claimed in claim 2, in which each indictor comprises a unique color.

4. The system as claimed in claim 3, in which each indictor comprises a screen background.

5. The system as claimed in claim 3, in which each type of data displayed has a specific color.

6. The system as claimed in claim 3, in which each indictor comprises a unique icon.

7. The system as claimed in claim 6, in which each icon comprises a color that is identical to the screen background which is associated with it.

8. The system as claimed in claim 1, used in association with a pump intended to administer medicines.

9. The system as claimed in claim 3 comprising a pop-up menu reprising the colors for each type of data, each type of data representing a function of the system.

10. The system as claimed in claim 9, comprising confirmation pages for receipt reprising the basic color of the chosen function.

11. The system as claimed in claim 8, comprising a basal function and a bolus function, each function being differentiated by means of said indictors.

12. The system as claimed in claim 8, for the injection of insulin, morphine, catecholamines, anticoagulants, hormones or peptides.

13. The system as claimed in claim 8, comprising an occlusion alarm which is produced in such a way as to be triggered from the instant at which a predefined duration of occlusion of the pump has been reached.
